(19) United States
(12) Patent Application Publication
(10) Pub. No.: US 2025/0374211 A1
(43) Pub. Date: Dec. 4, 2025

(54) COMPUTERIZED METHOD AND SYSTEM FOR BASE STATION TIMING CALIBRATION

(71) Applicant: VERIZON PATENT AND LICENSING INC., Basking Ridge, NJ (US)

(72) Inventors: Asif Dawoodi GANDHI, Edison, NJ (US); Chin CHIU, Allen, TX (US); Jack Anthony SMITH, Melissa, TX (US); Ravikumar PATTABIRAMAN, Hillsborough, NJ (US)

(73) Assignee: VERIZON PATENT AND LICENSING INC., Basking Ridge, NJ (US)

(21) Appl. No.: 18/679,538

(22) Filed: May 31, 2024

(51) Int. Cl. H04W 56/00; H04J 3/06

(52) U.S. Cl. CPC H04W 56/0015; H04J 3/0661; H04W 56/006

(57) ABSTRACT

Techniques for calibrating base station timing for user equipment (UE) positioning determination are disclosed. In one embodiment, a computerized method is disclosed comprising obtaining signal transmission and reception data samples for a base station and user equipment (UE) pairing, determining an observed downlink communication timing value and an observed uplink communication timing value for the base station and UE pairing using the obtained data samples, determining a true over the air (true OTA) value using the observed downlink and uplink communication timing values, determining a timing correction using the true OTA and one of the observed downlink and uplink communication timing values; and calibrating a timing of the base station using the determined timing correction.

### BACKGROUND INFORMATION

A service area of a telecommunications network, such as the 5G (Fifth Generation) communications network, can be divided into geographic areas, or cells. Each cell can include radio access network (RAN) equipment, such as a cellular base station (or cell tower), to which wireless devices within the cell's geographic area can communicate to access services, such as and without limitation the Internet, telephone network, location identification, and the like.

### BRIEF DESCRIPTION OF THE DRAWINGS

FIG. 1 provides an example illustrating components of a communications network, such as a 5G network for use in accordance with one or more embodiments of the present disclosure;

FIG. 2 provides an example illustrating an offset caused by a timing differential in accordance with one or more embodiments of the present disclosure;

FIG. 3 provides an example illustrating hyperbolas associated with base station pairings in accordance with embodiments of the present disclosure;

FIG. 4 provides an example illustrating an adjustment made to correct an offset in accordance with one or more disclosed embodiments;

FIG. 5 provides an example illustrating components of an analysis engine for use in determining a correction value for a base station in accordance with one or more embodiments of the present disclosure;

FIG. 6 provides an example illustrating base station and UE timing information for use in accordance with one or more embodiments of the present disclosure;

FIG. 7 provides an example of two UE and base station pairings and corresponding values determined for the pairings in accordance with embodiments of the present disclosure;

FIG. 8 provides a timing correction determination process flow in accordance with one or more embodiments of the present disclosure; and

FIG. 9 is a block diagram illustrating a computing device for use in accordance with one or more embodiments of the present disclosure.

### DETAILED DESCRIPTION OF EXAMPLE EMBODIMENTS

Techniques for calibrating base stations, such as next generation node Bs (gNBs), evolved Node Bs (eNBs), in a wireless communications, or cellular, network, such as a 5G communications network are disclosed. Disclosed embodiments provide a mechanism for calibrating the gNBs relative to each other, using a single cell-round trip time (SC-RTT) technique. Embodiments of the present disclosure detect and make adjustments for timing misalignments among base stations.

Embodiments of the present disclosure can be used for, inter alia, determining an accurate, precise geographic location (or position) of a wireless device, or user equipment (UE), in communication with a base station in the wireless communications network. In accordance with one or more embodiments, a base station's timing can be calibrated relative to one or more other base stations so that timing misalignment can be removed from wireless device, e.g., UE, geographic location, position determinations.

Embodiments of the present disclosure can be used as an “offline” fix of the timing misalignment. Embodiments of the present disclosure can be used to improve UE location estimation. While embodiments of the present disclosure are discussed in connection with UE location estimation, it should be apparent that base station timing realignment, calibration, can be used for other applications and provide a number of positive impacts on current and future wireless systems. By way of one non-limiting example, base station timing misalignment information determined using one or more embodiments of the present disclosure can be used to time align, e.g., synchronize, communication between base stations. To further illustrate, timing misalignment information can be used by a base station to accurately identify the transmission time of a signal received from another base station.

Two or more time-calibrated, or synchronized, base stations can be used to determine the geographic location of a UE. Base stations with timing misalignments—base stations that are not time-calibrated, or synchronized, relative to each other base station used in determining a UE's geographic location can introduce timing errors resulting in an inaccurate UE geographic location determination. Calibrating, or aligning or synchronizing, the timing of a base station relative to each other base station used in a UE geographic location determination, in accordance with embodiments of the present disclosure, results in a more precise, accurate UE geographic location determination.

In accordance with one or more embodiments, a timing adjustment, or correction, determined for a base station can be used to correct a base station's timing. A base station typically serves a geographic area and acts as a primary base station for a number of UEs currently located within the geographic area. For a UE, its primary base station is typically the base station with which the UE is using to access the communications network. As the UE changes geographic location, the UE may be served by a different base station.

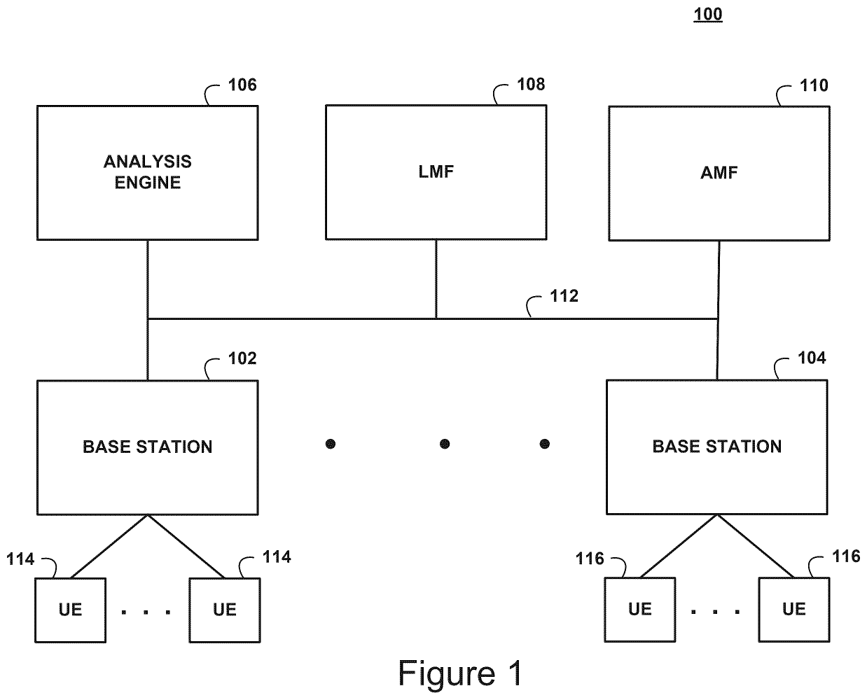

FIG. 1 provides an example illustrating components of a communications network, such as a 5G network for use in accordance with one or more embodiments of the present disclosure. While embodiments of the present disclosure are described herein in connection with a cellular network, such as a 5G communication network, the present disclosure can be practiced with other types of communication networks. In example 100 shown in FIG. 1, network 112 can comprise one or more types of communication networks and can include a 5G communication network.

In example 100, each base station 102, 104 acts as a primary base station for a number of UEs 114, 116. A primary base station refers to the base station that a UE 114, 116 is using to connect to network 112. In example 100, base station 102 is the primary base station for UEs 114 and base station 104 is acting as the primary base station for UEs 116.

In accordance with one or more embodiments of the present disclosure, analysis engine 106 can be configured to detect a timing issue associated with a base station 102, 104 and determine a correction that can be used to re-calibrate the base station 102, 104.

A base station 102, 104 transmits frames in accordance with an internal clock. A timing issue can occur when the internal clock causes the base station 102, 104 to transmit its frame(s) at a different time that another base station 102, 104.

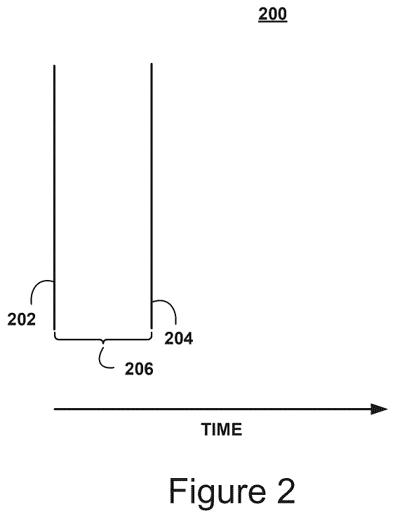

FIG. 2 provides an example illustrating an offset caused by a timing differential in accordance with one or more embodiments of the present disclosure. In example 200, reference line 202 can represent the start of a frame boundary for base station 102. By way of a non-limiting example, reference line 202 can represent the time at which the base station 102 transmits a signal, such as a positioning reference signal (PRS). Reference line 204 can represent the start of a frame boundary for base station 104. Reference line 204 can represent the time at which base station 104 transmits a PRS, for example. Offset 206 represents a time difference between the two frame boundary transmissions.

Analysis engine 106 can be configured to detect offset 206 and determine a correction for offset 206. As is discussed in more detail below, in accordance with one or more embodiments, analysis engine 106 can use observed signal transmission timing sample data for a given base station 102, 104 and a number of UEs for which the base station is the primary base station to determine a correction value to re-align (re-calibrate or synchronize) the timing of the base station 102, 104 relative to each other base station 102, 104. By way of some non-limiting examples, the observed signal transmission timing sample data can be collected by the base station 102, 104, LMF 108, access and mobility management function (AMF) 110, or the like.

In accordance with one or more embodiments, the correction value determined for a base station 102, 104 can be used to determine a geographic location of a UE 114, 116. By way of some non-limiting examples, a correction value for a base station 102, 104 can be used by a UE 114, 116, location management function (108), or the like to determine a geographic location of the UE 114, 116.

For purposes of illustration, analysis engine 106 is shown as a separate component in example 100. In accordance with one or more embodiments, some or all of the functionality of analysis engine 106 can be incorporated in base station 102, 104, LMF 108 or AMF 110. Although not shown in example 100, analysis engine 106 can comprise a number of components, modules or the like.

In accordance with one or more embodiments, a base station's correction, or timing adjustment, can be determined using an observed SC-RTT for each of a number of UEs 114, 116 in communication with their primary base station 102, 104. For a given UE 114, 116, the observed SC-RTT can comprise an observed downlink communication timing value and an observed uplink communication timing value.

The observed downlink communication timing value—e.g., an observed downlink over the air (DL_OTA_TOT) measurement—can be a time differential between the time that the base station 102, 104 transmits a signal in the downlink direction, e.g., a positioning reference signal (PRS), to the UE 114, 116 and the time that the UE 114, 116 receives the signal, where the base station 102, 104 determines the time of transmission (e.g., based on the base station's 102, 104 internal clock) and the UE 114, 116 determines the time of receipt (e.g., based on the UE's 114, 116 internal clock). The observed uplink communication timing value—e.g., an uplink over the air time of travel (UL_OTA_TOT) measurement—can be a time differential determined using a signal, e.g., a Sounding Reference Signal (SRS) sent in the uplink direction by the UE 114, 116 to the base station 102, 104.

In accordance with one or more embodiments, the observed downlink and uplink communication timing values (e.g., DL_OTA_TOT and UL_OTA_TOT) can be used to determine a true OTA_TOT, which can be used with either the observed downlink communication timing value (e.g., DL_OTA_TOT) or the observed uplink communication timing value (e.g., UP_OTA_TOT) to determine a timing adjustment relative to the base station 102, 104 and the UE 114, 116. In accordance with one or more embodiments, the time adjustment determined relative to the base station 102, 104 and each of a number (e.g., 2 or more) of UEs 114, 116 for which the base station 102, 104 is the primary base station can be used to determine a timing adjustment specific to the base station 102, 104—i.e., a correction value used as the base station's 102, 104 timing adjustment to align or synchronize its timing relative to other base stations 102, 104.

While embodiments of the present disclosure are described using DL_OTA_TOT and UL_OTA_TOT measurements, it should be apparent that any measurements can be used with sample data to determine observed downlink and uplink communication timing values.

In accordance with one or more embodiments, the timing adjustment determined for each base station 102, 104 can be used with a positioning method, e.g., Downlink Time Difference of Arrival (DL OTDOA) positioning method, to determine a geographic location of a UE 114, 116. DL OTDOA uses a time of arrival (TOA) of signals received by the UE 114, 116 from multiple base stations 102, 104 to determine the UE's 114, 116 geographic location. In accordance with embodiments of the present disclosure, a mis-aligned TOA corresponding to a base station 102, 104 can be corrected, or adjusted, using the correction value determined for the base station 102, 104 by analysis engine 106.

As is discussed below, a TOA can be received from a number of base stations 102, 104, such as the UE's 114, 116 primary base station 102, 104 paired with another base station 102, 104 and at least one other pairing of two base stations 102, 104.

In accordance with embodiments of the present disclosure, the TOA of each base station 102, 104 that is being used is adjusted using the correction value, or timing adjustment, determined for the base station 102, 104 by analysis engine 106. By way of a non-limiting example, analysis engine 106 can provide a base station's 102, 104 correction value to LMF 108, which can provide correction value to the UE 114, 116 (or other component determining a geographic location of the UE 114, 116). The correction value can be used to make any timing adjustment needed for a base station's 102, 104 TOA.

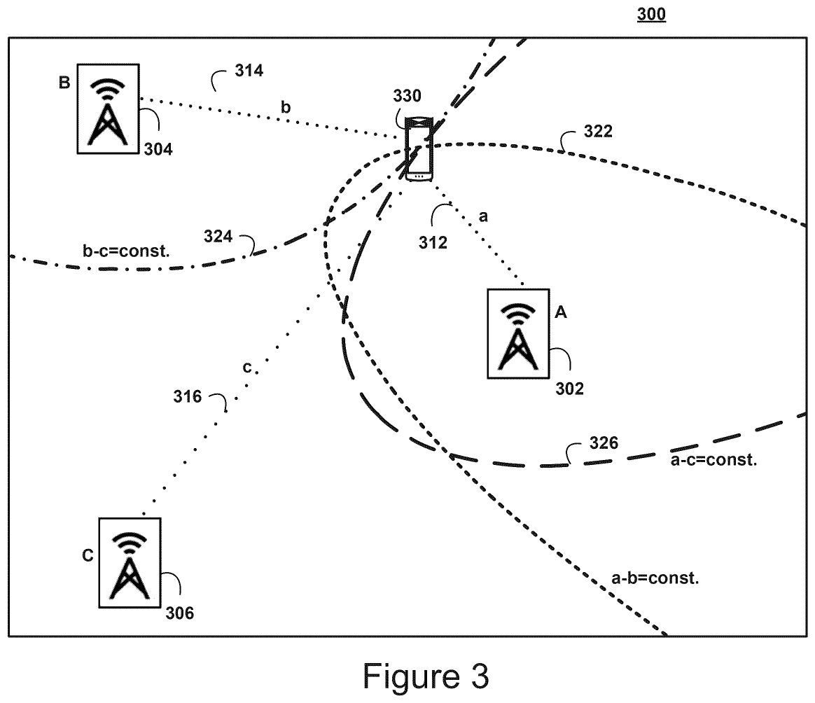

FIG. 3 provides an example illustrating hyperbolas associated with base station pairings in accordance with embodiments of the present disclosure. In example 300 shown in FIG. 3, each hyperbola 322, 324 and 326 formed from a pair of TOAs corresponding to a respective pair of base stations 302, 304, 306. For example, hyperbola 322 is formed using TOA 314 and TOA 312, hyperbola 324 is formed using TOA 316 and TOA 314, and hyperbola 326 is formed using TOA 316 and TOA 312. Two of the hyperbolas, e.g., hyperbola 322 and 326 can be used to determine the geographic location of UE 330. Assuming that base stations 302 and 306 are time synchronized, the intersection of hyperbolas 322 and 326 can be used as an accurate reflection of the geographic location of UE 330. However, timing differences associated with one or both of base stations 302 and 306 will cause errors in hyperbola 326, which will result in the determination of an inaccurate geographic location of UE 330.

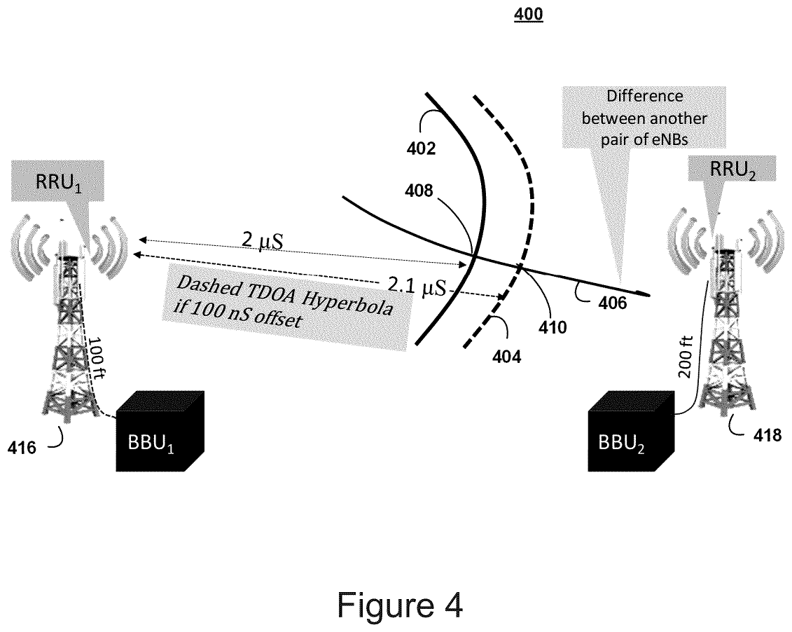

FIG. 4 provides an example illustrating an adjustment made to correct an offset in accordance with one or more disclosed embodiments. Example 400 illustrates the impact an offset, such as offset 206 shown in FIG. 2, has in determining a UE's geographic location using a positioning method such as a downlink (DL) Observed Time Difference of Arrival (OTDOA) position method. In example 400, base station 416 is shown to have an offset of 100 nanoseconds (nS).

In example 400, hyperbola 406 can be generated using the TOAs for base station 418 and a third base station not shown in the example. That is, hyperbola 406 can represent the TOA of base station 418 relative to (e.g., a difference from) the TOA of the third base station.

Hyperbola 404 can represent the pair of TOAs corresponding to base stations 416 and 418, where the TOA of base station 416 includes the 100 nS timing offset—i.e., 2.1 microseconds (μS)—2.0 μS=0.1 μS, or 100 nS. Hyperbola 404 is determined using the TOA including the 100 nS timing offset. The timing offset causes hyperbola 404 to be offset from hyperbola 402, which is formed using the time-adjusted TOA for base station 416. By way of a non-limiting example, the 100 nS offset in timing can correlate to a 100 foot offset between hyperbolas 402 and 404—e.g., 100 ft offset=1 ft/nS*100 nS timing offset, where 1 ft/nS is approximately the speed of light.

As shown in example 400, the 100 foot offset results in different intersection points with hyperbola 406. Hyperbolas 404 and 406 intersect at an intersection point 410 that differs from the intersection point 408 of hyperbolas 406 and 402. Intersection point 408 is a more accurate indicator of a UE's geographic location. Using intersection point 410 to determine a UE's geographic location results in an inaccurate geographic location determination.

Embodiments of the present disclosure determine the amount of the offset corresponding to base station 416 caused by the mis-aligned timing of base station 416 transmissions and adjust the timing information for base station 416 to remove the offset. Hyperbola 402 represents the corrected hyperbola formed from the TOA corresponding to base station 418 and the corrected TOA corresponding to base station 416, where the corrected TOA of base station 416 is corrected to remove the 100 nS offset using a correction value determined in accordance with one or more embodiments of the present disclosure. Hyperbolas 402 and 406 can be used to determine a geographic location of a UE using intersection point 408. The geographic location determination using hyperbolas 402 and 406 reflecting each base station's true OTA-TOT results in a more precise, accurate geographic location for a UE than the geographic location determination that is based on hyperbola 404 generated using an mis-aligned TOA.

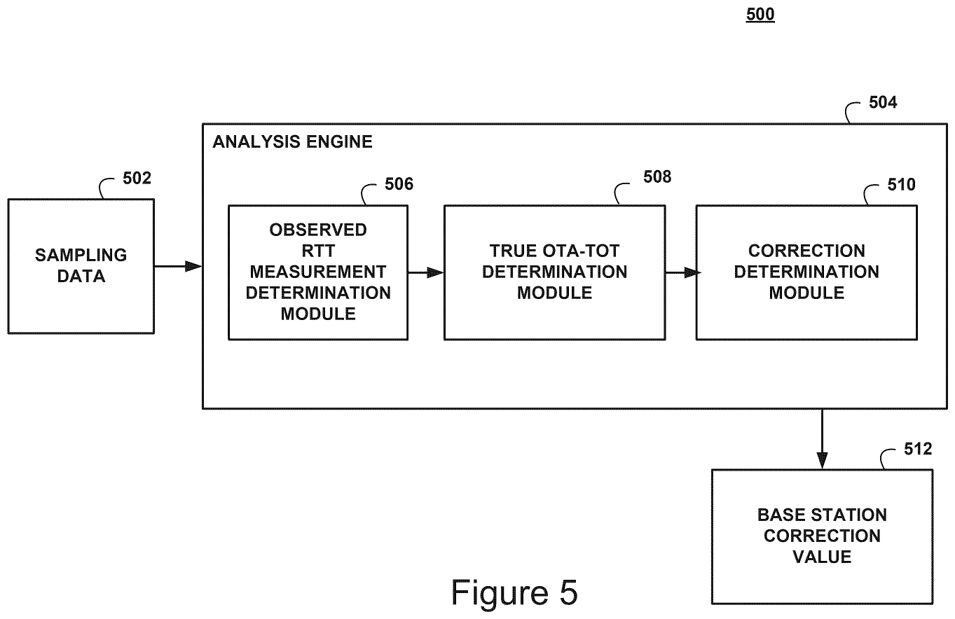

FIG. 5 provides an example illustrating components of an analysis engine for use in determining a correction value for a base station in accordance with one or more embodiments of the present disclosure. In example 500, analysis engine 504 can generate a correction value for each of a number of base stations 102, 104, where each base station's 102, 104 correction value is determined using sampling, or sample, data 502 corresponding to the base station 102, 104 and a number of UEs 114, 116 for which the base station 102, 104 is the primary base station.

In accordance with one or more embodiments, sampling data 502 can comprise signal transmission and reception data samples for a base station and user equipment (UE) pairing. In accordance with one or more embodiments, for each UE 114, 116 in the number of UEs being sampled, sampling data 502 can comprise at least one round trip time (RTT) data sample comprising base station timing information, gnbRxTx, and UE timing information, ueRxTx. The base station and UE timing information can be collected in connection with the transmission of a signal, PRS, sent by the base station 102, 104 to the UE 114, 116 and the transmission of a signal, a SRS, sent by the UE 114, 116 to the base station 102, 104 in response.

In accordance with one or more embodiments, the base station timing information, gnbRxTx, comprises a transmission time stamp, gNB Tx time to, and a reception time stamp, gNB Rx time t₃, and the UE timing information, ueRxTx, can comprise a reception time stamp, UE Rx time t₁, and a transmission time stamp, UE Tx time t₂.

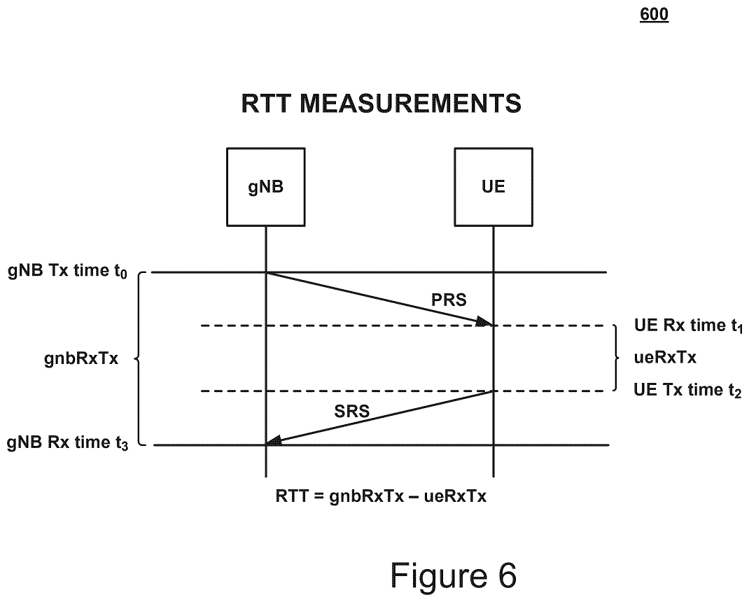

FIG. 6 provides an example illustrating base station and UE timing information for use in accordance with one or more embodiments of the present disclosure. In example 600, a base station 102, 104 (e.g., the component labeled gNB in example 600) sends a signal, such as a PRS, to a UE 114, 116 (e.g., the component labeled UE in example 600). According to the base station 102, 104, the PRS is sent at time to, or time stamp gNB Tx time to. As is discussed below, the gNB Tx time t₀ time stamp is determined by the base station 102, 104 internal time clock, and UE 114, 116 is unaware of any misalignment between the base station's 102, 104 internal time clock and the UE's 114, 116 internal time clock.

According to the UE 114, 116, it receives the PRS from the base station at time t₁, or time stamp UE Rx time t₁. In example 600, the UE 114, 116 sends an SRS to the base station 102, 104 in response. According to the UE 114, 116, the SRS is sent at time t₂, or time stamp UE Tx time t₂. According to the base station 102, 104, it receives the SRS from the base station at time t₃, or time stamp gNB Rx time t₃.

As shown in example 600, the base station's 102, 104 timing information can be used to determine a measurement, gnbRxTx, which is representative of the time difference between the PRS transmission time (i.e., the gNB Tx time t₀ time stamp) and the SRS reception time (i.e., the gNB Rx time t₃ time stamp).

The UE's 114, 116 timing information can be used to determine a measurement, ueRxTx, which is representative of the time difference between the PRS reception time (i.e., the UE Rx time t₁ time stamp) and the SRS transmission time (i.e., the UE Tx time t₂ time stamp).

As shown in example 600, a round trip transmission time (RTT) can be determined by subtracting ueRxTx from gnbRxTx. In example 600, the RTT is measured between an individual UE 114, 116 and an individual base station 102, 104. In accordance with embodiments of the present disclosure, the RTT can be used to eliminate time misalignments, synchronization issues, etc.

The value ueRxTx can correspond to measurement 5.1.cc of document R1-191633 from the 3^{rd} Generation Partnership Project (3GPP R1-191633, and gnbRxTx can correspond to measurement 5.2.bb of that document. Measurement 5.1.cc can be used to identify the UE Tx time t₂ and the UE Rx time t₁ time stamps. Measurement 5.2.bb can be used to identify gNB Rx time t₃ and the gNB Tx time t₀ time stamps. A frame transmission event at a base station 102, 104 can be identified using the gNB Tx time t₀ time stamp. With reference to § 5.1.9 of the R1-191633 document, TUE-GNSS can be used to measure the UE Rx time t₁ time stamp. In addition, the UE Rx time t₁ time stamp can be obtained from measure 5.1.cc.

In accordance with one or more embodiments, base station 102, 104 and UE 114, 116 times stamps can be referenced at the device's antenna point.

By way of a non-limiting example, assuming that there is no timing differential between base station's 102, 104 internal clock and UE's 114, 116 internal clock, the true over the air time of travel, or true OTA_TOT, of a PRS sent by base station 102, 104 to UE 114, 116 can be determined by subtracting the gNB Tx time t₀ time stamp from the UE Rx time t₁ time stamp. However, a timing error caused by a timing differential between the internal clocks results in an untrue OTA_TOT that is propagated to any geographic location determination that relies on a true OTA_TOT and is unaware of the difference between the true OTA and the untrue OTA.

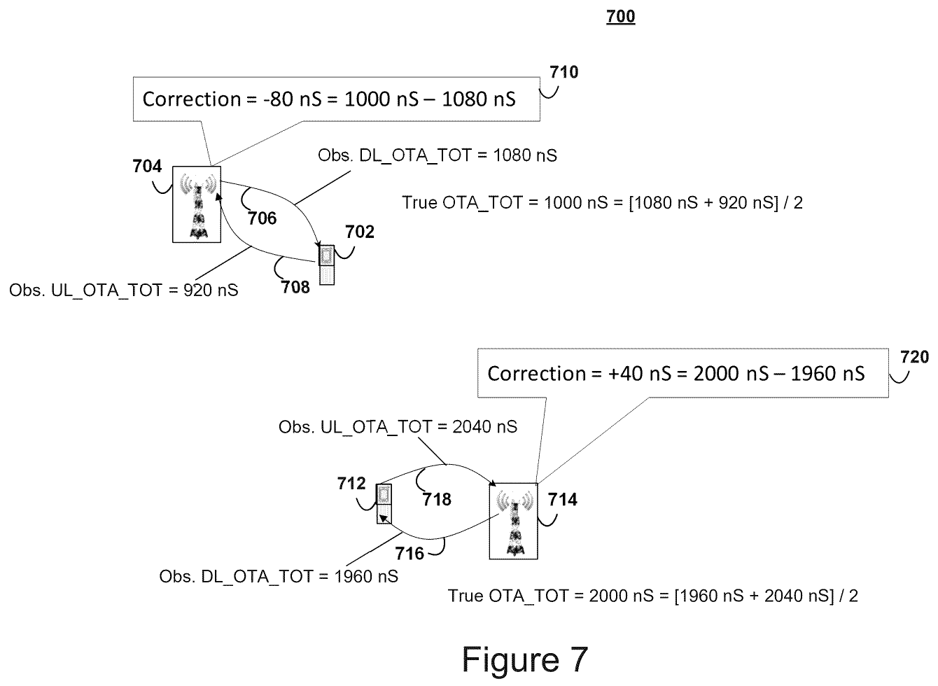

As is discussed in more detail with reference to FIG. 7, in accordance with disclosed embodiments, analysis engine 504 can determine the timing differential, account for the timing differential to determine a true OTA_TOT, and use the determined true OTA_TOT to determine a correction value to correct the base station's 102, 104 timing issue. As discussed herein, the base station's 102, 104 correction value can be determined using the correction value determined for each of a number of UEs 114, 116 connected to the base station 102, 104. The correction value determined for the base station 102, 104 by analysis engine 106, 504 can be used in determining a more accurate, precise geographic location of a UE 114, 116.

Referring again to FIG. 5, sampling data 502 can comprise RTT sample data for each of a number of UEs 114, 116 that are being sampled in connection with an individual base station 102, 104. The base station can be the primary base station 102, 104 for each UE 114, 116 being sampled. By way of a non-limiting example, sampling data 502 can be obtained at a periodic interval (e.g., one a day, once a week, etc.) during less busy (e.g., off peak) times. For each RTT sample taken for a UE 114, 116 and base station 102, 104 pairing, the RTT sample data comprises base station timing information comprising a transmission time stamp, gNB Tx time to, and a reception time stamp, gNB Rx time t₃, and UE timing information comprising a reception time stamp, UE Rx time t₁, and a transmission time stamp, UE Tx time t₂.

Module 506 of analysis engine 504 can use RTT sampling data 502 corresponding to a UE 114, 116 and base station 102, 104 pairing to determine an observed UL_OTA_TOT value and an observed DL_OTA_TOT value using exemplary Expressions 1 and 2, respectively:

$$Obs . UL\_OTA \_TOT = gNB Rx time {t}_{3} - UE Tx time {t}_{2} , \qquad Expr . 1$$

$$Obs . DL\_OTA \_TOT = UE Rx time {t}_{1} - gNB Tx time {t}_{0} , \qquad Expr . 2$$

In accordance with one or more embodiments, an observed RTT can be determined by combining the observed UL_OTA_TOT and DL_OTA_TOT measurements. As discussed below, the observed UL_OTA_TOT and DL_OTA_TOT values can be used to determine a true OTA_TOT, which can be used with the observed DL_OTA_TOT to determine a base station's 102, 104 correction value.

FIG. 7 provides an example of two UE and base station pairings, observed UL_OTA_TOT and DL_OTA_TOT values, true OTA_TOT values and resulting correction values determined in accordance with embodiments of the present disclosure. With reference to a pairing of UE 702 and base station 704, module 506 can determine the observed DL_OTA_TOT value of 1080 nS using the gNB Tx time t₀ and UE Rx time t₁ time stamps associated with signal 706 and Expression 2, and the observed UL_OTA_TOT value of 920 nS using the gNB Rx time t₃ and UE Tx time t₂, time stamps associated with signal 708 and Expression 1. In a similar manner, module 506 can use the timing information associated with signals 716 and 718 to determine the observed UL_OTA_TOT value of 2040 nS and the DL_OTA_TOT value of 1960 nS associated with the pairing of UE 712 and base station 714.

Referring again to FIG. 5, module 508 can use the observed UL_OTA_TOT and DL_OTA_TOT values determined for each UE 702, 712 and base station 704, 714 pairing by module 506 to determine a true OTA_TOT using the following exemplary expression:

$$True OTA\_TOT = [ Obs . DL\_OTA \_TOT + Obs . UL\_OTA \_TOT ] / 2 , \qquad Expr . 3$$

Referring to FIG. 7, the true OTA_TOT value for the UE 702 and base station 704 pairing is 1000 nS and 2000 nS for the UE 712 and base station 714 pairing.

With reference to FIG. 5, module 510 of analysis engine 504 can determine a correction value for each UE 702, 712 and base station 704, 714 pairing using the following exemplary expression:

$$Correction = True OTA\_TOT - Obs . DL\_OTA \_TOT \qquad Expr . 4$$

In Expression 4, the correction value is determined using the observed downlink communication timing value (e.g., DL_OTA_TOT). In accordance with one or more embodiments, for an uplink-based measurement like Timing Advance (TA), the correction value can be determined using the observed uplink communication timing value, as illustrated in the following exemplary expression:

$$Correction = True OTA\_TOT - Obs . UL\_OTA \_TOT \qquad Expr . 5$$

With reference to example 700 of FIG. 7, using either Expression 4 or Expression 5, the correction value for the UE 702 and base station 704 pairing can determined to be −80 nS, and the correction value for the UE 712 and base station 714 pairing can determined to be +40 nS.

In example 700, base stations 704 and 714 are shown with a single UE. In accordance with one or more embodiments, base station 704, 714 can be the primary base station for multiple UEs and a correction value can be determined using multiple ones of the UEs for which the base station 704, 714 is currently acting as the primary base station. As a result, multiple correction values can be determined by module 510. Module 510 can combine the multiple correction values and determine an aggregate correction value for the base station 704, 714. In accordance with one or more embodiments, the aggregate correction value can be a median, mean, average, etc. determined using the combined correction values.

In accordance with one or more embodiments, base station correction value 512 can be an aggregate of the correction values determined in connection with multiple ones of the UEs 702, 712 currently connected to the base station 704, 714, e.g., some or all of the UEs 702, 712 for which the base station 704, 714 is the primary base station.

Referring again to FIG. 1, in accordance with one or more embodiments, the number of UEs 114, 116 used in determining an aggregate correction value for a base station 102, 104 can be determined in accordance with a desired accuracy threshold. The following table provides an illustrative example:

| | | N-VALUE (# OF UEs/SAMPLES) | | | |
|---|---|---|---|---|---|
| Sigma | Epsilon | 90% | 95% | 99% | 99.9% |
| 50 | 10 | 250 | 500 | 2500 | 25,000 |
| 250 | 50 | 250 | 500 | 2500 | 25,000 |
| 50 | 30 | 28 | 55 | 275 | 2,780 |
| 250 | 10 | 6,250 | 12,500 | 62,500 | 62,500 |
| 5000 | 10 | 2.5 million | | | |

In accordance with one or more embodiments a timing UE-to-UE variance can be taken into account in determining a number of UEs 114, 116 to use in determining an aggregate correction value for a base station 102, 104. In the above table, sigma can represent the standard deviation of the timing variation from UE 114, 116 to UE 114, 116.

Epsilon can represent a desired timing accuracy, in nS. In the case of time division duplex (TDD), a UE-to-UE timing variance can be a source of inaccuracy. By way of a non-limiting example, UE-to-UE accuracy might be in the range of 10-30 nS for typical UEs. In the case of frequency division duplex (FDD), another source of inaccuracy can be the different paths that a signal can take on the uplink and the downlink. By way of a non-limiting example, 250 nS is a reasonable estimation of the inaccuracy in the FDD case.

In one non-limiting example, Chebyshev's inequality can be used in determining a number of UE samples. Chebyshev's inequality can be represented by the following exemplary expression:

$$P ( \vert {\overline{X}}_{n} - μ \vert \geq ε ) \leq \frac{{σ}^{2}}{n {ε}^{2}} ; \qquad Expr . 6$$

where σ (sigma) represents the standard deviation in the timing variation from UE to UE, ε (epsilon) represents a desired level of accuracy, and n represents the corresponding number of samples given the timing variation and the desired level of accuracy.

By way of a non-limiting example, an acceptable value for epsilon is 10 nS (which works out to approximately 3 meters) for TDD and 30 nS (which works out to approximately 10 meters) for FDD. In this example, 3 meters for TDD and 10 meters for FDD is being used as an acceptable level of accuracy in determining geographic positioning.

Based on the above and using 90% accuracy as a threshold level of accuracy, the number of UEs 114, 116 whose correction values are used in determining an aggregate correction value for a base station 102, 104 can be set to be 250 samples as a minimum number of UEs 114, 116, although it will be recognized that other accuracy threshold levels and sample sizes can be utilized. As shown in the above table, using 500 UE samples yields a higher level of accuracy. In accordance with one or more embodiments, the samples can be collected over a period of time and during periods of minimum network impact, if necessary. Additionally, the collection of samples can be a continuous process with the previous values being used until an updated value is available.

In accordance with one or more embodiments, a base station 102, 104 can be configured to include some or all of the modules of analysis engine 106, 504. In accordance with one or more embodiments, the base station 102, 104 can obtain sampling data 502 from the UEs 114, 116 for which the base station is acting as the primary base station. In accordance with one or more embodiments, a network function, such as AMF 110 or LMF 108, can be configured to obtain sampling data 502. In accordance with one or more embodiments, a network function, such as LMF 108, can be configured to include some or all of the modules of analysis engine 106, 504.

In accordance with one or more embodiments, correction value 512 determined for a base station 102, 104 can be provided to LMF 108 and used by LMF 108 to re-calibrate a base station 102, 104.

In accordance with one or more embodiments, an analysis engine 106, 504 is associated with one or more base stations 102, 104 in network 112, such that a correction value 512 can be determined for each base station 102, 104. The correction value 512 determined for a base station 102, 104 can be used with the correction value 512 determined for another base station 102, 104 to determine an accurate hyperbola representing a corrected DL OTDOA corrected using the correction values 512 determined for the pair of base stations 102, 104. The corrected DL OTDOA can be represented using the following exemplary expression:

$$Corrected DL OTDOA \{ {gNB}_{i} - {gNB}_{j} \} = UE Measured DL OTDOA [ {gNB}_{i} - {gNB}_{j} ] + {CorrectiongNB}_{i} - {CorrectiongNB}_{j} , \qquad Expr . 7$$

where gNBᵢ and gNBⱼ represent a pair of base stations 102, 104 whose TOAs are used to determine a hyperbola (representing a hyperbola) used in determining a geographic location of a UE 114, 116. By way of a non-limiting example, assuming that base stations 704 and 714 are used to determine the geographic location of UE 702, correction values 710 and 720 can be used to synchronize, or align, the timing of base stations 704 and 714. That is, the TOA associated with base station 704 can be adjusted using correction value 710 and the TOA associated with base station 714 can be adjusted using correction value 720, and the adjusted TOAs can be used to determine a corrected DL OTDOA, which can be used together with the corrected DL OTDOA of another base station pairing to determine the geographic location of UE 702.

In accordance with one or more embodiments, a corrected value can be used for each base station 102, 104 used in determining the geographic location of a UE 114, 116. Continuing with the above non-limiting example, the corrected value 720 associated with base station 714 can be used in determining the geographic location of UE 702 even though base station 714 is not the primary base station of UE 702.

In accordance with one or more embodiments, the correction value 512 determined by analysis engine 106, 504 for each base station 102, 104 used in determining the geographic location of UE 114, 116 can be provided to the UE 114, 116 and used to determine the geographic location of the UE 114, 116.

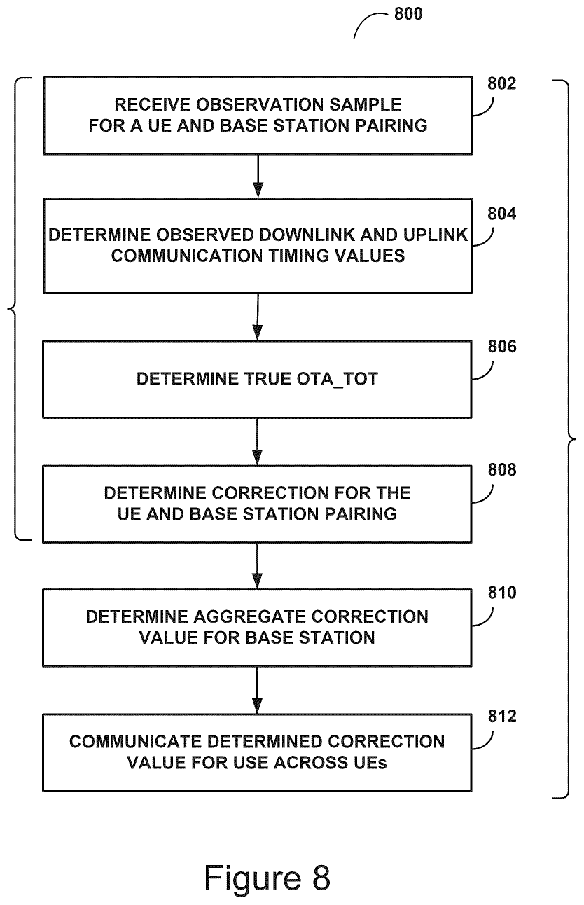

FIG. 8 provides a timing correction determination process flow in accordance with one or more embodiments of the present disclosure. In accordance with one or more embodiments, exemplary process 800 of FIG. 8 can be performed by analysis engine 106, 504. According to exemplary process 800, sampling data 502 obtained for a UE 114, 116 and base station 102, 104 pairing can be used to determine correction value 512 for the base station 102, 104. Process 800 can be performed for each base station 102, 104 in a communications network 112 to align the timing of a base station 102, 104 with each other base station 102, 104 using the correction value 512 determined for each base station 102, 104 using process 800. In accordance with one or more embodiments, the correction value 512 determined for a base station 102, 104 can be provided to a component of the communications network, such as UE 114, 116, LMF 108 associated with the base station 102, 104, etc., to calibrate, or adjust, the timing of the base station 102, 104. The adjusted timing determined for the base station 102, 104 using a correction value 512 can be used in determining a geographic location of a UE 114, 116.

In accordance with one or more embodiments, steps 802-812 can be performed for a base station 102, 104, and steps 802-808 can be repeated for each UE 114, 116 involved in determining a correction value 512 for the base station 102, 104.

At step 802, observation samples for a UE and base station pairing can be received. In accordance with one or more embodiments, the observation samples can be sampling data 502 received by analysis engine 106, 504. By way of a non-limiting example, the sampling data 502 can be received in connection with a given UE 114, 116 and base station 102, 104 pairing.

At step 804, observed downlink and uplink communication timing values can be determined. By way of a non-limiting example, the observed downlink and uplink communication timing values, e.g., DL_OTA_TOT and UL_OTA_TOT values, can be determined using the sampling data 502 received at step 802 and Expressions 1 and 2. Step 804 can be performed by module 506 of analysis engine 106, 504.

At step 806, a true OTA_TOT can be determined. By way of a non-limiting example, the true OTA_TOT can be determined by module 508 using the observed downlink and uplink communication timing values (e.g., DL_OTA_TOT and UL_OTA_TOT values) determined at step 804 and Expression 3. Step 806 can be performed by module 508 of analysis engine 106, 504.

At step 808, a correction for the UE and base station pairing can be determined. By way of a non-limiting example, the correction value for a UE 114, 116 and a base station 102, 104 pairing can be determined using Expression 4, the true OTA_TOT determined at step 806 and the observed DL_OTA_TOT determined at step 804. Alternatively, the correction value can be determined using Expression 5, the true OTA_TOT and the observed UL_OTA_TOT. Step 808 can be performed by module 510 of analysis engine 106, 504.

In accordance with one or more embodiments, steps 802-808 can be repeated for each UE 114, 116 being used to determine the correction value for a base station 102, 104. As discussed, the number of UEs 114, 116 can be based on a desired level of accuracy. As discussed, the UEs 114, 116 used in determining the base station's 102, 104 correction value can be UEs 114, 116 for which the base station 102, 104 is the primary base station. When a correction value has been determined for each UE 114, 116 being used to determine the base station's 102, 104 correction value, processing can continue to step 810.

At step 810, an aggregate correction value can be determined. By way of a non-limiting example, the correction value determined for each UE 114, 116 via steps 802-808 can be combined and an aggregate correction value can be determined using the combined correction values. By way of a further non-limiting example, the aggregate correction value can be determined to be a median, mean, average, etc. value of the combined correction values. Step 810 can be performed by module 510 of analysis engine 106, 504 to determine correction value 512 for a base station 102, 102.

At step 812, the determined correction value can be communicated for use across UEs. By way of a non-limiting example, the correction value determined for a base station 102, 104 can be communicated by analysis engine 106, 504 to the base station 102, 104, a UE 114, 116, LMF 108, AMF 110, etc. In accordance with one or more embodiments, a base station's 102, 104 correction value 512 can be used across UEs 114, 116—i.e., any UE 114, 116—including UEs 114, 116 for which the base station 102, 104 is not the primary base station. By way of a non-limiting example, the correction value 512 determined for a base station 102, 104 can be used for any UE 114, 116 that requests DL OTDOA-related measurement data from the base station 102, 104. The correction value 512 determined for a base station 102, 104 can be used to adjust the timing associated with the base station 102, 104.

In accordance with one or more embodiments of the present disclosure, the correction value 512 determined for a respective base station 102, 104 can be used to determine a corrected DL OTDOA (e.g., using Expression 7), which can be used to determine a geographic location of a UE 114, 116. The corrected DL OTDOA can be used in conjunction with other geographic location techniques, such as and without limitation SC UL/DL angle of arrival (AOA), maximum likelihood (ML) UL/DL AOA, timing advance (TA), multi-cell (MC)-RTT, etc. techniques.

As discussed herein, embodiments of the present disclosure use SC-RTT in calibrating a base station 102, 104. While MC-RTT can be used with disclosed embodiments in calibrating, or re-calibrating a base station 102, 104, MC-RTT uses timing measurements between UEs 114, 116 and base stations 102, 104 that are not primary base stations to the UEs 114, 116. For example, with reference to FIG. 1, MC-RTT can involve using timing measurement data associated with signals sent between base station 102 and a UE 116, which uses base station 104 as its primary base station.

For MC-RTT, a base station 102, 104 must monitor UEs 114, 116 that are being serviced by another base station 102, 104. To illustrate, base station 102 must monitor its own UEs 114 as well as UEs 116 for which base station 104 is acting as the primary base station. In comparison to using SC-RTT, the number of UEs that a base station 102, 104 must monitor using MC-RTT increases dramatically (e.g., by a factor of 5-10). In addition, signaling increases, which negatively impacts a base station's capacity. Furthermore, MC-RTT uses a special positioning sounding reference signal (P-SRS) to be implemented.

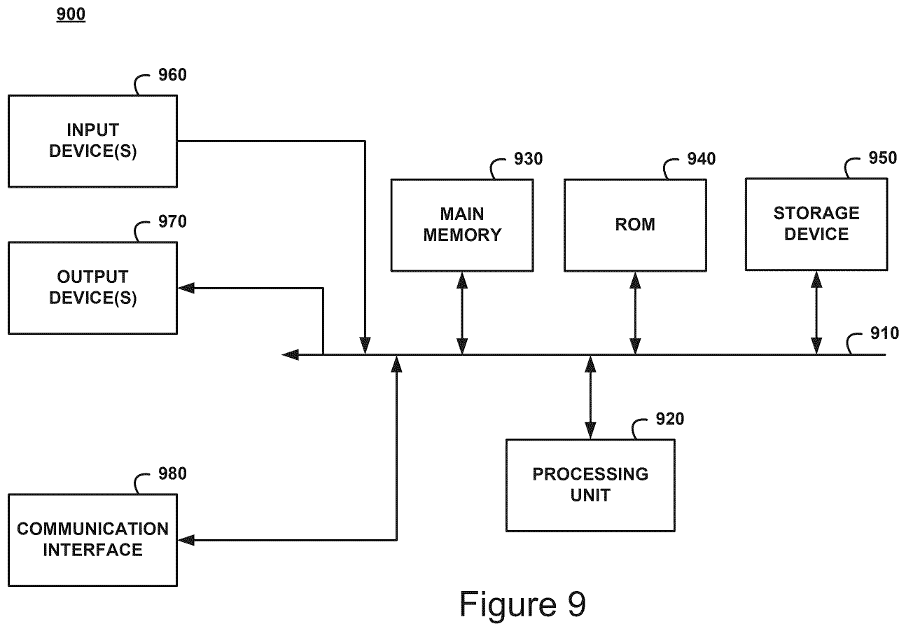

FIG. 9 is a block diagram illustrating a computing device showing an example of a client device (e.g., UE 114, 116), communications network component (such as LMF 108, AMF 110, etc.), server device, etc. used in the various embodiments of the disclosure. In accordance with one or more embodiments, modules of analysis engine 504 described herein can be implemented on one or more computing devices.

Device 900 can include a bus 910, a processing unit 920, a main memory 930, a read only memory (ROM) 940, a storage device 950, an input device(s) 960, an output device(s) 970, and a communication interface 980. Bus 910 can include a path that permits communication among the elements of device 900.

Processing unit 920 can include one or more processors or microprocessors which may interpret and execute instructions. Additionally, or alternatively, processing unit 920 can include processing logic that executes one or more operations of a process(es).

Main memory 930 can include a random access memory (RAM) or another type of dynamic storage device that may store information and, in some implementations, instructions for execution by processing unit 920. ROM 940 can include a ROM device or another type of static storage device (e.g., Electrically Erasable Programmable ROM (EEPROM)) that may store static information and, in some implementations, instructions for use by processing unit 920. Storage device 950 can include a magnetic, optical, and/or solid state (e.g., flash drive) recording medium and its corresponding drive. Main memory 930, ROM 940 and storage device 950 can each be referred to herein as a “non-transitory computer-readable medium” or a “non-transitory storage medium.” The processes/methods set forth herein can, at least in part, be implemented as instructions that are stored in main memory 930, ROM 940 and/or storage device 950 for execution by processing unit 920.

Input device 960 can include one or more mechanisms that permit an operator (e.g., a user) to input information to device 900, such as, for example, a keypad or a keyboard, a display with a touch sensitive panel, voice recognition and/or biometric mechanisms, etc. Output device 970 can include one or more mechanisms that output information to the operator, including a display, a speaker, etc. Communication interface 980 may include one or more transceivers that enable device 900 to communicate with other devices and/or systems. For example, communication interface 980 may include wired and/or wireless transceivers for communicating via an electronic communications network.

The configuration of components of device 900 illustrated in FIG. 9 is for illustrative purposes only. Other configurations may be implemented. Therefore, device 900 can include additional, fewer and/or different components than those depicted in FIG. 9.

At least some embodiments of the present disclosure are related to the use of device 900 for implementing some or all of the techniques described herein. According to one embodiment, those techniques are performed by device 900 in response to processing unit 920 executing one or more sequences of one or more processor instructions contained in main memory 930. Such instructions, also called computer instructions, software and program code, may be read into main memory 930 from another computer-readable medium, such as a storage device 950 or a network link (not shown). Execution of the sequences of instructions contained in main memory 930 causes processing unit 920 to perform one or more of the method steps described herein. In alternative embodiments, hardware, such as ASIC, may be used in place of or in combination with software. Thus, embodiments of the present disclosure are not limited to any specific combination of hardware and software, unless otherwise explicitly stated herein.

The present disclosure has been described with reference to the accompanying drawings, which form a part hereof, and which show, by way of non-limiting illustration, certain example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, the subject matter may be embodied as methods, devices, components, or systems. Accordingly, embodiments may, for example, take the form of hardware, software, firmware, or any combination thereof (other than software per se). The following detailed description is, therefore, not intended to be taken in a limiting sense.

Throughout the specification and claims, terms may have nuanced meanings suggested or implied in context beyond an explicitly stated meaning. Likewise, the phrase “in some embodiments” as used herein does not necessarily refer to the same embodiment, and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms such as “and,” “or,” or “and/or,” as used herein may include a variety of meanings that may depend at least in part upon the context in which such terms are used. Typically, “or” if used to associate a list, such as A, B, or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures, or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for the existence of additional factors not necessarily expressly described, again, depending at least in part on context.

The present disclosure has been described with reference to block diagrams and operational illustrations of methods and devices. It is understood that each block of the block diagrams or operational illustrations, and combinations of blocks in the block diagrams or operational illustrations, can be implemented by means of analog or digital hardware and computer program instructions. These computer program instructions can be provided to a processor of a general purpose computer to alter its function as detailed herein, a special purpose computer, ASIC, or other programmable data processing apparatus, such that the instructions, which execute via the processor of the computer or other programmable data processing apparatus, implement the functions/acts specified in the block diagrams or operational block or blocks. In some alternate implementations, the functions/acts noted in the blocks can occur out of the order noted in the operational illustrations. For example, two blocks shown in succession can in fact be executed substantially concurrently or the blocks can sometimes be executed in the reverse order, depending upon the functionality/acts involved.

For the purposes of this disclosure, a non-transitory computer-readable medium (or computer-readable storage medium/media) stores computer data, which data can include computer program code (or computer-executable instructions) that is executable by a computer, in machine-readable form. By way of example, and not limitation, a computer-readable medium may comprise computer-readable storage media, for tangible or fixed storage of data, or communication media for transient interpretation of code-containing signals. Computer-readable storage media, as used herein, refers to physical or tangible storage (as opposed to signals) and includes without limitation volatile and non-volatile, removable and non-removable media implemented in any method or technology for the tangible storage of information such as computer-readable instructions, data structures, program modules or other data. Computer-readable storage media can tangibly encode computer-executable instructions that when executed by a processor associated with a computing device perform functionality disclosed herein in connection with one or more embodiments.

Computer-readable storage media includes, but is not limited to, RAM, ROM, EPROM, EEPROM, flash memory or other solid-state memory technology, CD-ROM, DVD, or other optical storage, cloud storage, magnetic storage devices, or any other physical or material medium which can be used to tangibly store thereon the desired information or data or instructions and which can be accessed by a computer or processor.

For the purposes of this disclosure a module is a software, hardware, or firmware (or combinations thereof) system, process or functionality, or component thereof, that performs or facilitates the processes, features, and/or functions described herein (with or without human interaction or augmentation). A module can include sub-modules. Software components of a module may be stored on a computer readable medium for execution by a processor. Modules may be integral to one or more servers, or be loaded and executed by one or more servers. One or more modules may be grouped into an engine or an application.

For the purposes of this disclosure the term “user,” “subscriber,” “consumer,” or “customer” should be understood to refer to a user of an application or applications as described herein and/or a consumer of data supplied by a data provider. By way of example, and not limitation, the term “user” or “subscriber” can refer to a person who receives data provided by the data or service provider over the Internet in a browser session, or can refer to an automated software application which receives the data and stores or processes the data.

Those skilled in the art will recognize that the methods and systems of the present disclosure may be implemented in many manners and as such are not to be limited by the foregoing exemplary embodiments and examples. In other words, functional elements being performed by single or multiple components, in various combinations of hardware and software or firmware, and individual functions, may be distributed among software applications at either the client level or server level or both. In this regard, any number of the features of the different embodiments described herein may be combined into single or multiple embodiments, and alternate embodiments having fewer than, or more than, all of the features described herein are possible.

Functionality may also be, in whole or in part, distributed among multiple components, in manners now known or to become known. Thus, myriad software/hardware/firmware combinations are possible in achieving the functions, features, interfaces and preferences described herein. Moreover, the scope of the present disclosure covers conventionally known manners for carrying out the described features and functions and interfaces, as well as those variations and modifications that may be made to the hardware or software or firmware components described herein as would be understood by those skilled in the art now and hereafter.

Furthermore, the embodiments of methods presented and described as flowcharts in this disclosure are provided by way of example in order to provide a more complete understanding of the technology. The disclosed methods are not limited to the operations and logical flow presented herein. Alternative embodiments are contemplated in which the order of the various operations is altered and in which sub-operations described as being part of a larger operation are performed independently.

In the preceding specification, various example embodiments have been described with reference to the accompanying drawings. However, it will be evident that various modifications and changes may be made thereto, and additional embodiments may be implemented without departing from the broader scope of the disclosed embodiments as set forth in the claims that follow. The specification and drawings are accordingly to be regarded in an illustrative rather than restrictive sense.

1. A method comprising:
obtaining, by a computing device, signal transmission and reception data samples for a base station and user equipment (UE) pairing;
determining, by the computing device, an observed downlink communication timing value and an observed uplink communication timing value for the base station and UE pairing using the obtained data samples;
determining, by the computing device, a true over the air (true OTA) value using the observed downlink and uplink communication timing values;
determining, by the computing device, a timing correction using the true OTA and one of the observed downlink and uplink communication timing values; and
calibrating, by the computing device, a timing of the base station using the determined timing correction.

2. The method of claim 1, further comprising determining a geographic location of one or more UEs based on the timing correction used to calibrate the base station's timing.

3. The method of claim 1, wherein the obtained data samples comprise timing information associated with a first signal sent by the base station to the UE and a second signal sent by the UE to the base station.

4. The method of claim 3, wherein the timing information associated with the first signal comprises time stamp information indicating a time of transmission of the first signal by the base station and time stamp information indicating a time of receipt of the first signal by the UE and the timing information associated with the second signal comprises time stamp information indicating a time of transmission of the second signal by the UE and time stamp information indicating a time of receipt of the second signal by the base station.

5. The method of claim 1, wherein the UE is one of multiple UEs paired with the base station to determine multiple correction values.

6. The method of claim 5, wherein the base station is a primary base station for each UE, of the multiple UEs, paired with the base station.

7. The method of claim 6, calibrating a timing of the base station using the determined timing correction further comprising:
determining, by the computing device, an aggregate correction value using the multiple correction values, wherein the timing of the base station is calibrated using the aggregate correction value.

8. The method of claim 7, wherein the aggregate correction value is used in an observed time difference of arrival (OTDOA) downlink positioning method for locating at least one UE.

9. The method of claim 7, wherein the aggregate correction value is used in determining a hyperbola corresponding to the base station and a second base station, the determined hyperbola being used in the OTDOA downlink positioning method.

10. The method of claim 7, wherein a number of UEs used in determining the aggregate correction value is determined using a threshold level of accuracy.

11. The method of claim 1, wherein the observed downlink communication timing value is an observed downlink over the air time of travel (DL_OTA_TOT) measurement and the observed uplink communication timing value is an observed uplink over the air time of travel (UL_OTA_TOT) measurement.

12. A non-transitory computer-readable storage medium tangibly encoded with computer-executable instructions that when executed by a processor associated with a computing device perform a method comprising:
obtaining signal transmission and reception data samples for a base station and user equipment (UE) pairing;
determining an observed downlink communication timing value and an observed uplink communication timing value for the base station and UE pairing using the obtained data samples;
determining a true over the air (true OTA) value using the observed downlink and uplink communication timing values;
determining a timing correction using the true OTA and one of the observed downlink and uplink communication timing values; and
calibrating a timing of the base station using the determined timing correction.

13. The non-transitory computer-readable storage medium of claim 12, wherein the obtained data samples comprise timing information associated with a first signal sent by the base station to the UE and a second signal sent by the UE to the base station.

14. The non-transitory computer-readable storage medium of claim 13, wherein the timing information associated with the first signal comprises time stamp information indicating a time of transmission of the first signal by the base station and time stamp information indicating a time of receipt of the first signal by the UE and the timing information associated with the second signal comprises time stamp information indicating a time of transmission of the second signal by the UE and time stamp information indicating a time of receipt of the second signal by the base station.

15. The non-transitory computer-readable storage medium of claim 12, wherein the UE is one of multiple UEs paired with the base station to determine multiple correction values.

16. The non-transitory computer-readable storage medium of claim 15, wherein the base station is a primary base station for each UE, of the multiple UEs, paired with the base station.

17. The non-transitory computer-readable storage medium of claim 16, calibrating a timing of the base station using the determined timing correction further comprising:
determining, by the computing device, an aggregate correction value using the multiple correction values, wherein the timing of the base station is calibrated using the aggregate correction value.

18. The non-transitory computer-readable storage medium of claim 17, wherein the aggregate correction value is used in an observed time difference of arrival (OTDOA) downlink positioning method for locating at least one UE.

19. The non-transitory computer-readable storage medium of claim 18, wherein the aggregate correction value is used in determining a hyperbola corresponding to the base station and a second base station, the determined hyperbola being used in the OTDOA downlink positioning method.

20. A device comprising:
a processor, configured to:
obtain signal transmission and reception data samples for a base station and user equipment (UE) pairing;
determine an observed downlink communication timing value and an observed uplink communication timing value for the base station and UE pairing using the obtained data samples;
determine a true over the air (true OTA) value using the observed downlink and uplink communication timing values;
determine a timing correction using the true OTA and one of the observed downlink and uplink communication timing values; and
calibrate a timing of the base station using the determined timing correction.
